(19) United States
(12) Patent Application Publication
(10) Pub. No.: US 2026/0159421 A1
(43) Pub. Date: Jun. 11, 2026

(54) HIGH-EFFICIENCY IN-SITU REMEDIATION DEVICE AND METHOD FOR DNAPLS-CONTAMINATED GROUNDWATER AQUIFERS

(71) Applicant: Chinese Research Academy of Environmental Sciences, Beijing (CN)

(72) Inventors: Fujun MA, Beijing (CN); Fanyang BU, Beijing (CN); Qingbao GU, Beijing (CN)

(21) Appl. No.: 19/294,991

(22) Filed: Aug. 8, 2025

(30) Foreign Application Priority Data
Dec. 10, 2024 (CN) 202411805867.4

(51) Int. Cl. C02F 1/40; C02F 101/32; C02F 103/06

(52) U.S. Cl. CPC C02F 1/40; C02F 2101/32; C02F 2103/06; C02F 2201/005

(57) ABSTRACT

A high-efficiency in-situ remediation device and method for DNAPLs-contaminated underground aquifers includes a workbench. An air supply device is fixed on a top of the workbench, a controller is fixed on the top of the workbench, and a steam generating device is fixed on the top of the workbench. By arranging the air supply device, a negative pressure vacuum can be formed inside the extraction assembly. By arranging the limiting assembly, external liquids such as groundwater and DNAPLs can enter the extraction assembly; and by using the arranged limitation assembly and extraction assembly in cooperation again, a positive pressure environment is formed inside the extraction assembly.

### CROSS-REFERENCE TO RELATED APPLICATIONS

This application claims priority to Chinese Patent Application No. 202411805867.4, filed on Dec. 10, 2024, the entire disclosure of which is incorporated herein by reference.

### TECHNICAL FIELD

The present application relates to the technical field of in-situ remediation of soil and groundwater, and specifically to a high-efficiency in-situ remediation device and method for DNAPLs-contaminated underground aquifers.

### BACKGROUND

For underground aquifers contaminated by organic substances, especially those polluted by dense non-aqueous phase liquids (DNAPLs) such as petroleum hydrocarbons and chlorinated hydrocarbons, groundwater pumping and treatment technology is widely applied in in-situ treatment techniques due to its advantages of good treatment effect and high economy. The remediation effect of groundwater pumping is mainly affected by factors such as pumping rate, well construction density, formation permeability, pollutant mobility, and pollutant viscosity. DNAPLs have the characteristics of high density, low water solubility, and high interfacial tension, making them more difficult to remediate than light non-aqueous phase liquids (LNAPLs). Commonly used pumping treatment equipment often fails to work effectively.

Currently, pumps used for groundwater pumping treatment on the market, such as above-ground vacuum self-priming pumps and submersible pumps, are mostly electrically driven with large flow rates, mainly suitable for groundwater extraction. However, in contaminated sites with high viscosity and mixed sediment, these pumps are prone to shutdown or damage due to insufficient suction. When remediating contaminated sites with a depth greater than 10 meters, ordinary submersible pumps and other pumps cannot pump the liquid in the extraction well to the ground collection tank due to the great depth and insufficient pressure. Moreover, DNAPLs have high specific gravity and viscosity. When they settle at the bottom of the well and mix with sediment, the difficulty of suction increases sharply. Their high viscosity will adhere to the pump impellers or the inner wall of the extraction pipeline, which is likely to cause equipment damage and pipeline blockage after long-term use. Therefore, the pumping device needs to maintain a certain safe distance from the bottom of the well during application. In addition, the pumping volume and depth of centrifugal pumps such as vacuum self-priming pumps and submersible pumps are proportional to the motor speed. Although increasing the speed can increase the pumping volume and vacuum degree, which is beneficial to extraction, affected by the characteristics of DNAPLs, a larger pumping rate does not significantly improve their removal efficiency, but instead increases the costs of electricity and sewage treatment.

An existing patent, CN117600212A, discloses a layered multiphase extraction method, although they are based on layered and phased extraction of pollution and dynamically adjust the target layer to concentrate the vacuum degree, do not solve the problem of difficult extraction due to high viscosity and high specific gravity of DNAPLs. Therefore, we provide a high-efficiency in-situ remediation device and method for DNAPLs-contaminated underground aquifers to solve the above problems.

### SUMMARY

The purpose of the present application is to make up for the deficiencies of the existing technologies and provide a high-efficiency in-situ remediation device and method for DNAPLs-contaminated underground aquifers.

To achieve the above purpose, the present application provides the following technical solutions:
A high-efficiency in-situ remediation device suitable for Dense Non-Aqueous Phase Liquids (DNAPLs)-contaminated underground aquifers, comprising a workbench,
wherein an air supply device is fixed on a top of the workbench, a controller is fixed on the top of the workbench, a steam generation device is fixed on the top of the workbench, a chemical dosing device is fixed on the top of the workbench, a liquid storage tank is fixed on the top of the workbench, a liquid outlet pipe is fixed to an inside of the liquid storage tank, a sewage treatment device is fixed on the top of the workbench, and an inside of the sewage treatment device is fixed to an end of the liquid outlet pipe far away from the liquid storage tank;
an extraction assembly is provided below the workbench, and an extraction assembly comprises a hanging line that is driven and wound at a wellhead; an end of the hanging line far away from the workbench is fixed with a hanging ring, and an outer surface of the hanging ring is fixed with a groundwater pump body;
an air inlet pipe is fixed to and communicated with an inside of the groundwater pump body, and an end of the air inlet pipe far away from the groundwater pump body is fixed to an inside of the air supply device;
an air inlet valve is fixed to an inside of the air inlet pipe, and an air outlet pipe is fixed to and communicated with the inside of the groundwater pump body, and an end of the air outlet pipe far away from the groundwater pump body is communicated with atmosphere, and an exhaust valve is fixed to an inside of the air outlet pipe;
a piston is slidably connected to an inner wall of the groundwater pump body, and a spring is fixed to a bottom surface of the piston, and a limitation assembly is provided at an inside of the groundwater pump body, and the limitation assembly comprises a limitation ring fixed to an inner wall of the groundwater pump body;
a hollow disc is fixed to an upper surface of the limitation ring, and an upper surface of the hollow disc is fixed to an end of the spring far away from the piston; and
a sphere is slidably connected to an inner wall of the limitation ring, a heater is fixed on an outer surface of the groundwater pump body, and a heating pipe is fixed to and communicated with an inside of the heater, and an end of the heating pipe far away from the heater is fixed to and communicated with an inside of the steam generation device.

In one embodiment, a groundwater outlet pipe is fixed to and communicated with the inside of the groundwater pump body, and an end of the groundwater outlet pipe far away from the groundwater pump body is fixed to and communicated with an inside of the liquid storage tank, and a first check valve is fixed inside of the groundwater outlet pipe.

In one embodiment, a chemical dosing pipe is fixed to the inside of the groundwater pump body, and an end of the chemical dosing pipe far away from the groundwater pump body is fixed to an inside of the chemical dosing device, and a second check valve is fixed to an inside of the chemical dosing pipe.

A remediation method includes:
S1: equipment installation and commissioning: transporting the high-efficiency in-situ remediation device to a remediation site of the DNAPLs-contaminated underground aquifer, according to an actual situation of the remediation site, placing the workbench in a suitable position to ensure its stability of the workbench; installing and commissioning the air supply device, the controller, the steam generation device, the chemical dosing device, the liquid storage tank and the sewage treatment device in sequence; connecting a top end of the extraction assembly to the winch provided at the wellhead using the hanging line, and fixing a bottom end of the hanging line to the hanging ring to fix the groundwater pump body; lowering the groundwater pump body into the extraction well, so that a lower feed port of the groundwater pump body is located near an enrichment layer, to ensure that all pipes are connected smoothly;
S2: preparation of chemicals and hot water: according to a pollution degree and characteristics, preparing an appropriate amount of surfactant and emulsifier conditioning chemicals in the chemical dosing device, adding the chemicals into the groundwater pump body through the chemical dosing pipe; starting the steam generation device to heat water to a suitable temperature, wherein a generated hot steam is transported into the extraction well through the heating pipe and the heater for heating and conditioning the DNAPLs liquid;
S3: starting extraction and chemical addition: starting the air supply device to allow compressed air to enter the groundwater pump body through the air inlet pipe, pushing the piston to move downward against an elastic force of the spring to squeeze out the air in the pump body, and according to the preset program, closing the air inlet valve on the air inlet pipe and opening the exhaust valve on the air outlet pipe for exhaust, and at this time, the piston moving upward under a rebound force of the spring, forming a negative pressure vacuum environment in the groundwater pump body; under an action of negative pressure, pushing the sphere in the limitation assembly at the bottom to open by external liquid, and the external groundwater and DNAPLs liquid entering a pump body through the hollow disc and the limitation ring, and during an exhaust process, starting the solenoid valve and the second check valve on the chemical dosing pipe according to a signal from the controller; adding the conditioning chemicals in the chemical dosing device into the pump body through the chemical dosing pipe in a preset proportion to mix with extracted liquid, to prevent DNAPLs residue and blockage; repeating to continuously extract mixed liquid of groundwater and DNAPLs; closing the exhaust valve again and opening the air inlet valve; the air supply device supplying air again to make the piston move downward again, to form a positive pressure environment in the pump body, such that the sphere closes a bottom feed port under pressure, and the extracted liquid is discharged along the groundwater outlet pipe;
S4: parameter adjustment: timely adjusting an air supply pressure of the air supply device, an opening and closing time of the air inlet valve and exhaust valve, and chemical dosage parameters to ensure the stability and efficiency of the extraction process, and observing a treatment effect of the sewage treatment device on the extracted liquid, and adjusting a chemical formula or add other treatment chemicals according to water quality after treatment; and
S5: completing remediation and equipment cleaning: continuing to extract until a monitoring data shows that a content in groundwater reaches a predetermined remediation standard, or an extraction amount reaches a certain limit; stopping an extraction operation, lifting the groundwater pump body to a ground, cleaning the inside of the groundwater pump body and pipes and components of the high-efficiency in-situ remediation device to remove residual sediment and other impurities; properly processing a sludge in the sewage treatment device to prevent secondary pollution; maintaining the high-efficiency in-situ remediation device, checking wear of each component, and replacing vulnerable parts to prepare for a next remediation operation

Compared with the existing technologies, the high-efficiency in-situ remediation device and method for DNAPLs-contaminated underground aquifers have the following beneficial effects:

1. The present application can form a negative pressure vacuum inside the extraction assembly by arranging the air supply device. By arranging the limitation assembly, external groundwater and other liquids can enter the extraction assembly. Furthermore, through the cooperative use of the provided limitation assembly and the extraction assembly, a positive pressure environment is formed in the extraction assembly, and the limitation assembly will close the bottom liquid inlet of the extraction assembly, ensuring that the liquid extracted into the extraction assembly is smoothly discharged into the collection pool of the ground sewage treatment device, thereby effectively solving the problems of insufficient suction as well as easy blockage of the pump body and pipelines of traditional electrically driven pumps when dealing with DNAPLs due to their high viscosity and large specific gravity, improving the extraction efficiency, and overcoming the disadvantage that traditional centrifugal pumps cannot significantly improve the removal efficiency of DNAPLs by simply increasing the rotation speed to increase the amount of extracted groundwater.

2. The present application arranges the chemical addition system composed of the chemical dosing device, the chemical dosing pipe and the second check valve, conditioning materials such as surfactants and emulsifiers can be accurately added into the groundwater pump body at specific times, preventing the contaminated liquid from remaining on the inner wall of the groundwater pump body, further optimizing the extraction effect, and reducing the pressure on subsequent sewage treatment and lowering the treatment cost.

### BRIEF DESCRIPTION OF THE DRAWINGS

FIG. 1 is a three-dimensional front view of the present application.

FIG. 2 is a top view of the present application.

FIG. 3 is a schematic diagram of an extraction assembly of the present application.

FIG. 4 is a cross-sectional view of the present application.

FIG. 5 is a cross-sectional view of the extraction assembly of the present application.

FIG. 6 is a schematic diagram of the limitation assembly of the present application.

FIG. 7 is a schematic diagram of a downhole liquid level of the present application.

### DETAILED DESCRIPTION OF THE EMBODIMENTS

The principles and features of the present application are described below in conjunction with the accompanying drawings. The examples provided are only used to explain the present application and are not intended to limit the scope of the present application. The present application will be described in further detail below in conjunction with the accompanying drawings and embodiments.

### Embodiment 1

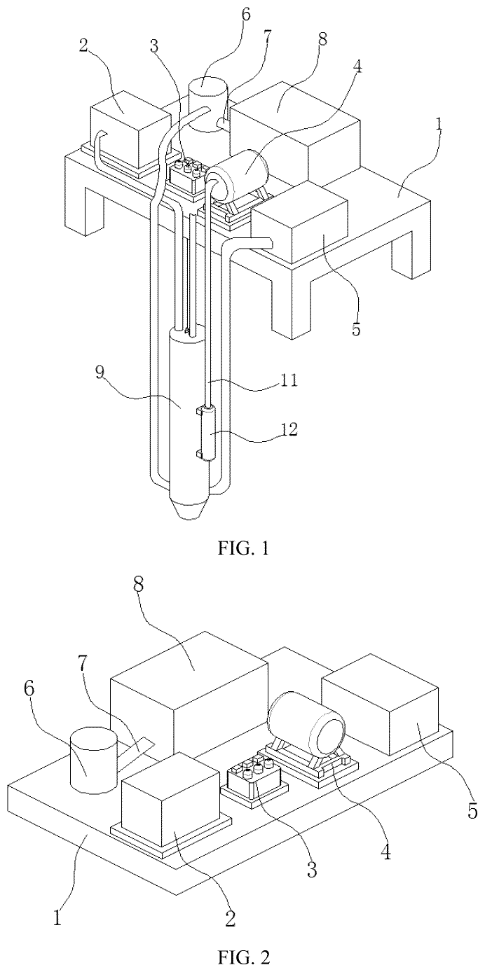

As shown in FIG. 1, FIG. 2 and FIG. 4, a high-efficiency in-situ remediation device and method for DNAPLs-contaminated underground aquifers includes a workbench 1. An air supply device 2 is fixed on a top of the workbench 1, a controller 3 is fixed on the top of the workbench 1, a steam generation device 4 is fixed on the top of the workbench 1, and a chemical dosing device 5 is fixed on the top of the workbench 1. A liquid storage tank 6 is fixed on the top of the workbench 1, and a liquid outlet pipe 7 is fixed to and communicated with the inside of the liquid storage tank 6. A sewage treatment device 8 is fixed on the top of the workbench 1, and the inside of the sewage treatment device 8 is fixed to the end of the liquid outlet pipe 7 far away from the liquid storage tank 6. An extraction assembly 9 is provided below the workbench 1, a limitation assembly 10 is provided inside the groundwater pump body 903, a heater 12 is fixed on an outer surface of the groundwater pump body 903, a heating pipe 11 is fixed to and communicated with the inside of the heater 12, and an end of the heating pipe 11 far away from the heater 12 is fixed to and communicated with the inside of the steam generation device 4.

In this embodiment, the air supply device 2 is responsible for providing gas, which is connected to the groundwater pump body 903 in the extraction assembly 9 through a specific pipeline to form a negative pressure vacuum inside the extraction assembly 9, thereby facilitating the extraction of groundwater and pollutants. The controller 3, as the “brain” of the entire system, is responsible for receiving various sensor signals and accurately controlling each component according to preset programs to ensure the efficiency and safety of the entire remediation process. The steam generation device 4 provides necessary thermal energy, which can be used to heat water or hot steam to improve the treatment effect. The chemical dosing device 5 is used to store and add various treatment chemicals, which may help decompose, dilute or emulsify pollutants, to prevent blockage of the pump and pipelines, and ensure the smooth discharge of liquids. The steam generation device 4 is connected to the heater 12 through the heating pipe 11, allowing preheating treatment of the liquid in the contaminated layer before extraction to improve its fluidity. The liquid storage tank 6 is used to temporarily store the pollutant-containing water extracted from the ground and the treated clean water. The liquid storage tank 6 is connected to the sewage treatment device 8 through the liquid outlet pipe 7 to form a complete liquid treatment loop. The sewage treatment device 8 further treats the pollutant-containing water flowing out of the liquid storage tank 6 to meet the discharge standards, and the treated clean water can be recycled or discharged into the natural environment. Below the workbench 1, there is an extraction assembly 9, which is the core part of the entire device. The extraction assembly 9 includes a hanging line 901 that can be driven and wound by a winch provided at the wellhead. An end of the hanging line 901 is fixed with a hanging ring 902 for hanging and fixing the groundwater pump body 903. A limitation assembly 10 is provided inside the groundwater pump body 903, which plays a key role in the extraction process. When a negative pressure is formed inside the extraction assembly 9, the limitation assembly 10 opens to allow external groundwater and other liquids to enter; when a positive pressure is formed inside the extraction assembly 9, the limitation assembly 10 closes to prevent liquid backflow and ensure that the extracted liquid can be smoothly discharged into a collection pool of the ground sewage treatment device 8. The heater 12 can heat and dilute the liquid near the pollutant enrichment layer to improve its fluidity, especially for DNAPLs, which are pollutants with high density, low water solubility and high interfacial tension. Heating can significantly reduce their viscosity, making them easier to be extracted and treated.

The working steps of this embodiment are as follows:

As shown in FIG. 1, FIG. 2 and FIG. 4, the entire device is transported to a remediation site of the contaminated underground aquifer. According to the actual situation of the site, the workbench 1 is placed in a suitable position to ensure its stability. Then the air supply device 2, the controller 3, the steam generation device 4, the chemical dosing device 5, the liquid storage tank 6, the sewage treatment device 8 and other components are installed in sequence, and commissioned to ensure that all components operate normally and are tightly connected without leakage. And a top end of the extraction assembly 9 is connected to the winch provided at the wellhead using the hanging line 901, and is fixed to the hanging ring 902 through the bottom end of the hanging line 901 to fix the groundwater pump body 903. Then the groundwater pump body 903 is placed into the extraction well, so that the lower feed port of the groundwater pump body 903 is located near the pollutant enrichment layer, and it ensures that all pipes are connected smoothly, such as the air inlet pipe 904, the air outlet pipe 906, groundwater outlet pipe 910, the chemical dosing pipe 912, etc., which are connected to the corresponding components correctly. Then the air supply device 2 and the extraction assembly 9 are started through the controller 3 to cooperate, so that external groundwater and other liquids can smoothly enter the extraction assembly 9. The contaminated liquid enters the groundwater pump body 903 through the limitation assembly 10 and is then transported to the liquid storage tank 6. During the extraction process, the heater 12 can heat the liquid outside the groundwater pump body 903 to improve the fluidity of the liquid, ensuring that it can easily flow into the groundwater pump body 903 to improve the treatment efficiency. If necessary, appropriate conditioning materials such as surfactants and emulsifiers are added into the groundwater pump body 903 through the chemical dosing device 5 and the chemical dosing pipe 912 to prevent the extracted contaminated liquid from remaining in the groundwater pump body 903 or causing blockage of the groundwater outlet pipe 910, further optimizing the extraction effect, and reducing the pressure on subsequent sewage treatment and lowering the treatment cost. The extracted contaminated liquid enters the sewage treatment device 8 for further treatment. After the treated clean water meets the discharge standards, it can be reused or discharged into the natural environment. During the entire remediation process, the controller 3 continuously monitors the operating status and parameters of each component, and makes adjustments and optimizations as needed. And the equipment is regularly maintained to ensure its long-term stable operation.

### Embodiment 2

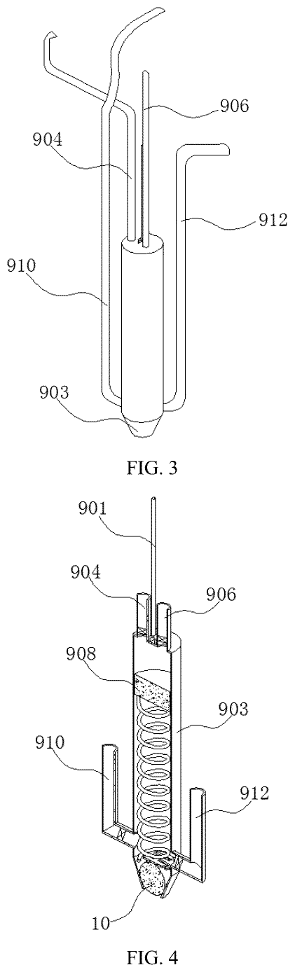

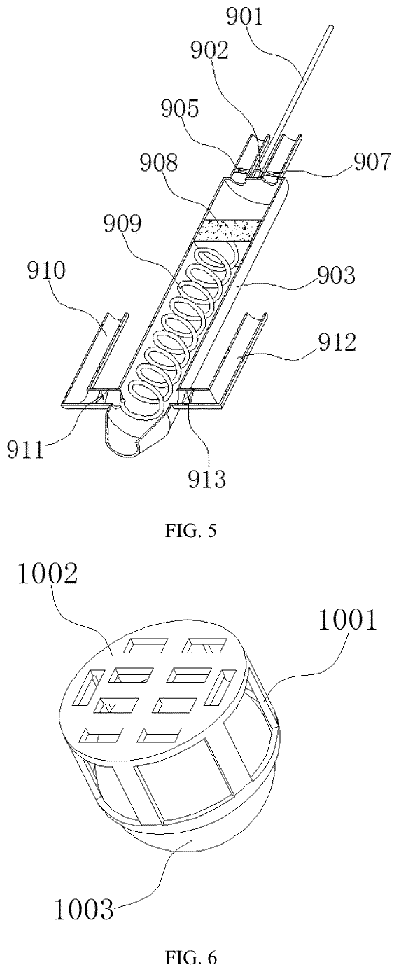

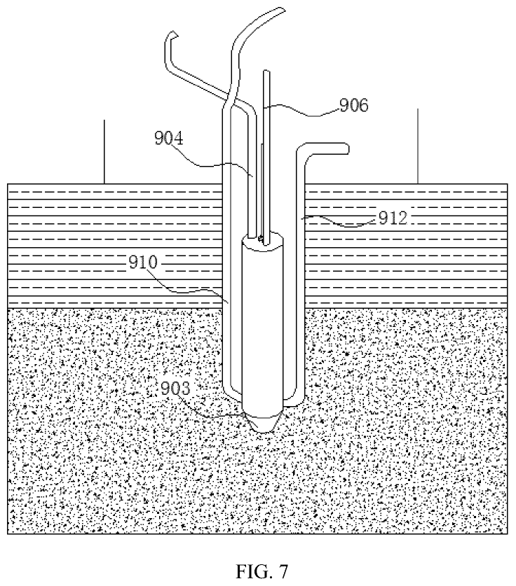

As shown in FIG. 1, FIG. 3, FIG. 4, FIG. 5 and FIG. 7, the extraction assembly 9 includes a hanging line 901 driven and wound by a winch at the wellhead. An end of the hanging line 901 is fixed with a hanging ring 902, and the outer surface of the hanging ring 902 is fixed with a groundwater pump body 903. The inside of the groundwater pump body 903 is fixed with an air inlet pipe 904, and an end of the air inlet pipe 904 far away from the groundwater pump body 903 is fixed with the inside of the air supply device 2. An air inlet valve 905 is fixed inside the air inlet pipe 904 The inside of the groundwater pump body 903 is fixed with an air outlet pipe 906, and an end of the air outlet pipe 906 far away from the groundwater pump body 903 is connected with the atmosphere. An exhaust valve 907 is fixed inside the air outlet pipe 906. An inner wall of the groundwater pump body 903 is slidably communicated with a piston 908, and a bottom surface of the piston 908 is fixed with a spring 909. The inside of the groundwater pump body 903 is fixed with a groundwater outlet pipe 910, and an end of the groundwater outlet pipe 910 far away from the groundwater pump body 903 is fixed with the inside of the liquid storage tank 6. A first check valve 911 is fixed inside the groundwater outlet pipe 910. The inside of the groundwater pump body 903 is fixed with a chemical dosing pipe 912, and an end of the chemical dosing pipe 912 far away from the groundwater pump body 903 is fixed with the inside of the chemical dosing device 5. A second check valve 913 is fixed inside the chemical dosing pipe 912.

In this embodiment, the extraction assembly 9, as the core part of the device, has an exquisite structural design and the components work together. An end of the hanging line 901 is connected with the winch provided at the wellhead, which can realize the retraction and release operation of the hanging line 901, thereby controlling the lifting of the groundwater pump body 903 in the extraction well. Another end of the hanging line 901 is connected with the hanging ring 902, and the hanging ring 902 is fixed on the outer surface of the groundwater pump body 903 to ensure that the groundwater pump body 903 is stable and reliable in the suspended state. The inside of the groundwater pump body 903 is communicated with the air inlet pipe 904 and the air outlet pipe 906. The air inlet pipe 904 is communicated with the inside of the air supply device 2, and the air outlet pipe 906 is communicated with the atmosphere. The air inlet valve 905 on the air inlet pipe 904 and the exhaust valve 907 on the air outlet pipe 906 can accurately control the inflow and outflow of gas. The piston 908 slides on the inner wall of the groundwater pump body 903, and the spring 909 provides elastic potential energy for the movement of the piston 908, enabling it to reciprocate under the action of air pressure, thereby realizing the extraction function. The groundwater outlet pipe 910 communicates the groundwater pump body 903 with the liquid storage tank 6, and the first check valve 911 is provided inside the groundwater outlet pipe 910 to effectively prevent liquid from flowing back into the groundwater pump body 903. The chemical dosing pipe 912 also communicates the groundwater pump body 903 with the chemical dosing device 5, and the second check valve 913 ensures that the chemicals can only flow into the groundwater pump body 903 in one direction, ensuring the accuracy and stability of chemical addition.

The working steps of this embodiment are as follows:

As shown in FIG. 1, FIG. 3, FIG. 4, FIG. 5 and FIG. 7, the air supply device 2 is started to allow compressed air to enter the groundwater pump body 903 through the air inlet pipe 904, the piston 908 is purshed to move downward against the elastic force of the spring 909. The sphere 1003 moves downward to block a conical opening at the bottom of the groundwater pump body 903 and squeeze out the air in the pump body. Then, according to the preset program, the air inlet valve 905 on the air inlet pipe 904 is closed and the exhaust valve 907 on the air outlet pipe 906 is opened for exhaust. At this time, the piston 908 moves upward under the rebound force of the spring 909, to form a negative pressure vacuum environment in the groundwater pump body 903. Under the action of negative pressure, the sphere 1003 in the limitation assembly 10 at the bottom is pushed away by the external liquid, and the sphere 1003 moves upward. The external groundwater and other liquids enter the groundwater pump body 903 through the hollow disc 1002 and the limitation ring 1001. After that, the exhaust valve 907 is closed again and the air inlet valve 905 is opened. The air supply device 2 supplies air again to make the piston 908 move downward again, to form a positive pressure environment in the pump body. The sphere 1003 moves downward under pressure to close a bottom feed port, ensuring that the extracted liquid is discharged along the groundwater outlet pipe 910. At the same time, during the air intake process, the solenoid valve and the second check valve 913 on the chemical dosing pipe 912 are opened according to the signal from the controller 3, and the conditioning chemicals in the chemical dosing device 5 are added into the pump body through the chemical dosing pipe 912 in a preset proportion to mix with the extracted liquid, preventing the residue and blockage of the contaminated liquid, repeating this cycle to continuously extract groundwater and the mixed liquid.

By installing a winch at the wellhead and adjusting the position of the extraction assembly 9, cross extraction of groundwater and contaminated liquid can be realized. Due to the low content of contaminated liquid in the stratum and its poor fluidity, extraction is generally carried out at intervals. During the intervals, extraction and remediation of contaminated groundwater can be carried out, realizing dual use of one pump.

To further improve the adaptability of the extraction assembly 9, the screen opening position of the extraction well matched with the extraction assembly 9 is designed into upper and lower sections, with a barrier section in the middle. When used for groundwater remediation, in addition to being used as the extraction assembly 9 for groundwater extraction treatment, the groundwater outlet pipe 910 of the extraction assembly 9 can pass through the barrier section in the middle of the groundwater extraction well without being connected to the ground groundwater extraction treatment device. Instead, after refitting the groundwater pump, together with the groundwater extraction well, it can be changed to an in-situ groundwater circulation well, which extracts groundwater from the lower section of the groundwater aquifer and transfers it to the upper section of the groundwater extraction well, realizing hydraulic exchange between the upper and lower layers of the groundwater aquifer and in-situ cleaning.

While the groundwater is hydraulically circulating, by adding material chemical and biological agents, such as hot water, redox agents, microbial agents, etc., the in-situ cleaning effect can be enhanced, and the in-situ addition and diffusion of remediation agents can be realized to enhance the remediation effect.

### Embodiment 3

As shown in FIG. 1, FIG. 4 and FIG. 6, the limitation assembly 10 includes a limitation ring 1001 fixed to the inner wall of the groundwater pump body 903. A hollow disc 1002 is fixed to the upper surface of the limitation ring 1001, and the upper surface of the hollow disc 1002 is fixed to an end of the spring 909 far away from the piston 908. A sphere 1003 is slidably connected to the inner wall of the limitation ring 1001.

In this embodiment, the limitation assembly 10 is a key component inside the groundwater pump body 903, which ensures that liquid can effectively enter the groundwater pump body 903 and closes the bottom feed port when a positive pressure environment is formed inside the groundwater pump body 903. Specifically, the limitation assembly 10 includes the following parts: the limitation ring 1001 is fixed to the inner wall of the groundwater pump body 903, which can limit the up and down movement of the sphere 1003 within a certain range, enabling it to open the liquid inlet of the groundwater pump body 903 in time to allow liquid to enter and block the inlet in time to prevent liquid from flowing out. The hollow disc 1002 is fixed to the upper surface of the limitation ring 1001, and its hollow design allows liquid to pass through. And the upper surface of the hollow disc 1002 is fixed to an end of the spring 909 far away from the piston 908. The limitation ring 1001 and the top hollow disc 1002 together form a platform that can support the top spring 909. A diameter of the sphere 1003 is slightly larger than the feed port at the bottom of the pump body, so when a positive pressure environment is formed inside the pump body, the sphere 1003 can close the bottom feed port under pressure to prevent liquid backflow.

The working steps of this embodiment are as follows:

As shown in FIG. 1, FIG. 4 and FIG. 6, when the device starts to work, first, air is supplied to the inside of the groundwater pump body 903 through the air supply device 2, so that the piston 908 moves downward under the push of the gas. Compressed air enters the inside of the groundwater pump body 903 along the air inlet pipe 904 to squeeze the piston 908 and the spring 909 to move downward for compression, squeezing out the air in the groundwater pump body 903, and the sphere 1003 will move downward to block the conical liquid inlet at the bottom end of the groundwater pump body 903; the air inlet valve 905 is closed and the exhaust valve 907 is opened, the piston 908 moves upward under the rebound action of the spring 909 to form a negative pressure vacuum in the groundwater pump body 903, the sphere 1003 below the groundwater pump body 903 is pushed away by the external liquid, and the external groundwater and other contaminated liquids enter the inside of the groundwater pump body 903. Then the exhaust valve 907 is closed and the air inlet valve 905 is opened, the piston 908 and the spring 909 are compressed again by the compressed air, and the liquid in the groundwater pump body 903 is discharged along the groundwater outlet pipe 910. During the downward movement of the piston 908, a positive pressure environment is formed in the groundwater pump body 903, and the sphere 1003 is pressed downward to block the conical liquid inlet at the bottom of the groundwater pump body 903, ensuring that the liquid extracted into the groundwater pump body 903 is smoothly discharged into the liquid storage tank 6 and the sewage treatment device 8 of the ground sewage treatment equipment along the groundwater outlet pipe 910, repeating this cycle to continuously extract groundwater and the mixed liquid, and treat them through the sewage treatment device 8, ultimately achieving the purpose of remediating the contaminated underground aquifer.

In the description of the present application, it should be understood that the terms “upper”, “lower”, “left”, “right” and other indications of orientation or positional relationship are based on the orientation or positional relationship shown in the drawings, which are only for the convenience of describing the present application and simplifying the description, rather than indicating or implying that the referred device or element must have a specific orientation, and be constructed and operated in a specific orientation. Therefore, it cannot be understood as a limitation to the present application. In addition, “first” and “second” are only for descriptive purposes, and cannot be understood as indicating or implying relative importance or implicitly indicating the number of indicated technical features. Therefore, the features defined with “first” and “second” may explicitly or implicitly include one or more of these features. In the description of the present application, unless otherwise specified, “plurality” means two or more.

It should be noted that the standard parts used in the present application can be purchased from the market, and special-shaped parts can be customized according to the description in the specification and the drawings. The specific connection modes of each part adopt the conventional means such as bolts, rivets and welding in the related art, and the machines, parts and equipment adopt the conventional models in the related art, which will not be described in detail by the inventor. In the description of the present application, it should be noted that unless otherwise clearly specified and limited, the terms “installation”, “connection” and “connection” should be understood in a broad sense, for example, it can be a fixed connection, a detachable connection, or an integral connection; it can be a mechanical connection or an electrical connection; it can be a direct connection or an indirect connection through an intermediate medium, or it can be the internal communication between two elements. For those skilled in the art, the specific meanings of the above terms in the present application can be understood according to specific situations.

The above is a detailed description of one embodiment of the present application, but the content is only a preferred embodiment of the present application, and cannot be considered as limiting the scope of implementation of the present application. All equivalent changes and improvements made according to the scope of the application of the present application should still belong to the scope covered by the patent of the present application.

What is claimed is:

1. A high-efficiency in-situ remediation device suitable for Dense Non-Aqueous Phase Liquids (DNAPLs)-contaminated underground aquifers, comprising a workbench,
wherein an air supply device is fixed on a top of the workbench, a controller is fixed on the top of the workbench, a steam generation device is fixed on the top of the workbench, a chemical dosing device is fixed on the top of the workbench, a liquid storage tank is fixed on the top of the workbench, a liquid outlet pipe is fixed to an inside of the liquid storage tank, a sewage treatment device is fixed on the top of the workbench, and an inside of the sewage treatment device is fixed to an end of the liquid outlet pipe far away from the liquid storage tank;
an extraction assembly is provided below the workbench, and an extraction assembly comprises a hanging line that is driven and wound at a wellhead; an end of the hanging line far away from the workbench is fixed with a hanging ring, and an outer surface of the hanging ring is fixed with a groundwater pump body;
an air inlet pipe is fixed to and communicated with an inside of the groundwater pump body, and an end of the air inlet pipe far away from the groundwater pump body is fixed to an inside of the air supply device;
an air inlet valve is fixed to an inside of the air inlet pipe, and an air outlet pipe is fixed to and communicated with the inside of the groundwater pump body, and an end of the air outlet pipe far away from the groundwater pump body is communicated with atmosphere, and an exhaust valve is fixed to an inside of the air outlet pipe;
a piston is slidably connected to an inner wall of the groundwater pump body, and a spring is fixed to a bottom surface of the piston, and a limitation assembly is provided at an inside of the groundwater pump body, and the limitation assembly comprises a limitation ring fixed to an inner wall of the groundwater pump body;
a hollow disc is fixed to an upper surface of the limitation ring, and an upper surface of the hollow disc is fixed to an end of the spring far away from the piston; and
a sphere is slidably connected to an inner wall of the limitation ring, a heater is fixed on an outer surface of the groundwater pump body, and a heating pipe is fixed to and communicated with an inside of the heater, and an end of the heating pipe far away from the heater is fixed to and communicated with an inside of the steam generation device.

2. The high-efficiency in-situ remediation device suitable for DNAPLs-contaminated underground aquifers according to claim 1, wherein a groundwater outlet pipe is fixed to and communicated with the inside of the groundwater pump body, and an end of the groundwater outlet pipe far away from the groundwater pump body is fixed to and communicated with an inside of the liquid storage tank, and a first check valve is fixed inside of the groundwater outlet pipe.

3. The high-efficiency in-situ remediation device suitable for DNAPLs-contaminated underground aquifers according to claim 1, wherein a chemical dosing pipe is fixed to the inside of the groundwater pump body, and an end of the chemical dosing pipe far away from the groundwater pump body is fixed to an inside of the chemical dosing device, and a second check valve is fixed to an inside of the chemical dosing pipe.

4. A remediation method using the high-efficiency in-situ remediation device for DNAPLs-contaminated underground aquifers according to claim 1, comprising:
S1: equipment installation and commissioning: transporting the high-efficiency in-situ remediation device to a remediation site of the DNAPLs-contaminated underground aquifer, according to an actual situation of the remediation site, placing the workbench in a suitable position to ensure its stability of the workbench; installing and commissioning the air supply device, the controller, the steam generation device, the chemical dosing device, the liquid storage tank and the sewage treatment device in sequence; connecting a top end of the extraction assembly to the winch provided at the wellhead using the hanging line, and fixing a bottom end of the hanging line to the hanging ring to fix the groundwater pump body; lowering the groundwater pump body into the extraction well, so that a lower feed port of the groundwater pump body is located near an enrichment layer, to ensure that all pipes are connected smoothly;
S2: preparation of chemicals and hot water: according to a pollution degree and characteristics, preparing an appropriate amount of surfactant and emulsifier conditioning chemicals in the chemical dosing device, adding the chemicals into the groundwater pump body through the chemical dosing pipe; starting the steam generation device to heat water to a suitable temperature, wherein a generated hot steam is transported into the extraction well through the heating pipe and the heater for heating and conditioning the DNAPLs liquid;
S3: starting extraction and chemical addition: starting the air supply device to allow compressed air to enter the groundwater pump body through the air inlet pipe, pushing the piston to move downward against an elastic force of the spring to squeeze out the air in the pump body, and according to the preset program, closing the air inlet valve on the air inlet pipe and opening the exhaust valve on the air outlet pipe for exhaust, and at this time, the piston moving upward under a rebound force of the spring, forming a negative pressure vacuum environment in the groundwater pump body; under an action of negative pressure, pushing the sphere in the limitation assembly at the bottom to open by external liquid, and the external groundwater and DNAPLs liquid entering a pump body through the hollow disc and the limitation ring, and during an exhaust process, starting the solenoid valve and the second check valve on the chemical dosing pipe according to a signal from the controller; adding the conditioning chemicals in the chemical dosing device into the pump body through the chemical dosing pipe in a preset proportion to mix with extracted liquid, to prevent DNAPLs residue and blockage; repeating to continuously extract mixed liquid of groundwater and DNAPLs; closing the exhaust valve again and opening the air inlet valve; the air supply device supplying air again to make the piston move downward again, to form a positive pressure environment in the pump body, such that the sphere closes a bottom feed port under pressure, and the extracted liquid is discharged along the groundwater outlet pipe;
S4: parameter adjustment: timely adjusting an air supply pressure of the air supply device, an opening and closing time of the air inlet valve and exhaust valve, and chemical dosage parameters to ensure the stability and efficiency of the extraction process, and observing a treatment effect of the sewage treatment device on the extracted liquid, and adjusting a chemical formula or add other treatment chemicals according to water quality after treatment; and
S5: completing remediation and equipment cleaning: continuing to extract until a monitoring data shows that a content in groundwater reaches a predetermined remediation standard, or an extraction amount reaches a certain limit; stopping an extraction operation, lifting the groundwater pump body to a ground, cleaning the inside of the groundwater pump body and pipes and components of the high-efficiency in-situ remediation device to remove residual sediment and other impurities; properly processing a sludge in the sewage treatment device to prevent secondary pollution; maintaining the high-efficiency in-situ remediation device, checking wear of each component, and replacing vulnerable parts to prepare for a next remediation operation.
